(19) United States
(12) Patent Application Publication
(10) Pub. No.: US 2017/0328552 A1
(43) Pub. Date: Nov. 16, 2017

(54) ILLUMINATION DEVICE

(71) Applicant: Taiwan Green Point Enterprises Co., Ltd., Taichung City (TW)

(72) Inventors: Chia-Tai CHEN, Taichung City (TW); Sheng-Hung YI, Taichung City (TW); Pen-Yi LIAO, Taichung City (TW)

(73) Assignee: Taiwan Green Point Enterprises Co., Ltd., Taichung City (TW)

(21) Appl. No.: 15/592,645

(22) Filed: May 11, 2017

(30) Foreign Application Priority Data
May 13, 2016 (TW) 105114822

(51) Int. Cl. F21V 29/74; F21V 29/89; F21V 23/00; F21V 27/02; F21V 23/02; F21Y 2115/10

(52) U.S. Cl. CPC F21V 29/745; F21V 27/02; F21V 23/02; F21V 29/89; F21V 23/001; F21Y 2115/10

(57) ABSTRACT

An illumination device includes a circuit board, a lamp seat, primary and secondary circuits, multiple conductive wires and at least one light-emitting element. The lamp seat includes a light exiting mount region. The primary circuit is disposed on the circuit board. The secondary circuit is disposed at the light exiting mount region. The conductive wires electrically connect the primary and secondary circuits. The light-emitting element is disposed at the light exiting mount region and is electrically connected to the secondary circuit. Another illumination device is also provided, which includes a circuit board, a lamp seat, primary and secondary circuits, multiple conductive wires and at least one light-emitting element.

### CROSS REFERENCE TO RELATED APPLICATION

This application claims priority of Taiwanese Patent Application No. 105114822, filed on May 13, 2016.

### FIELD OF INVENTION

Embodiments of the present disclosure generally relate to an illumination device, and more particularly to an illumination device including light-emitting devices (LEDs) for illumination.

### BACKGROUND

A conventional illumination device, such as an LED light bulb, generally includes a heat dissipating seat, an LED array, a case and an electronic module. The LED array is disposed on a top surface of the heat dissipating seat. The case is connected to an end of the heat dissipating seat opposite to the LED array and has a receiving space. The electronic module is disposed in the receiving space and is electrically connected to the LED array. The electronic module includes a circuit board, and primary and secondary circuits disposed on the circuit board. The primary circuit is electrically connected to an external power source, such as a domestic power outlet, and transforms and delivers electric power to the secondary circuit.

For safety concerns, various electronic components on the primary and secondary circuits should be kept with certain spacings, so that the electronic module has a considerable length and is space-occupying.

### SUMMARY

Certain embodiments of the disclosure provide an illumination device that may alleviate at least one of the drawbacks of the prior art.

The illumination device includes a circuit board, a lamp seat, a primary circuit, a secondary circuit, a plurality of conductive wires and at least one light-emitting element. The lamp seat includes a light exiting mount region. The primary circuit is disposed on the circuit board. The secondary circuit is disposed at the light exiting mount region. The conductive wires electrically connect the primary circuit and the secondary circuit. The at least one light-emitting element is disposed at the light exiting mount region and is electrically connected to the secondary circuit.

In certain embodiments of the disclosure, another illumination device is provided. The illumination device includes a circuit board, a lamp seat, a primary circuit, a secondary circuit, a plurality of conductive wires and at least one light-emitting element. The lamp seat is formed with an insulating surface. The primary circuit is disposed on the circuit board. The secondary circuit includes a circuit wiring that is disposed on the insulating surface and that includes at least one electronic component connected to the circuit wiring. The conductive wires are electrically connected between the primary circuit and the secondary circuit. The at least one light-emitting element is connected to the circuit wiring of the secondary circuit.

In certain embodiments of the disclosure, still another illumination device is provided. The illumination device includes a lamp seat, a circuit board, a primary circuit, a secondary circuit, a plurality of conductive wires and at least one light-emitting element. The lamp seat includes a light exiting mount region and defines a space. The circuit board is received in the space. The primary circuit is disposed on the circuit board. The secondary circuit is disposed at the light exiting mount region. The conductive wires electrically connect the primary circuit and the secondary circuit. The at least one light-emitting element is electrically connected to the secondary circuit.

### BRIEF DESCRIPTION OF THE DRAWINGS

Other features and advantages of the disclosure will become apparent in the following detailed description of the embodiment with reference to the accompanying drawings, of which:

FIG. 1 is a schematic exploded view of an embodiment of an illumination device according to the present disclosure;

FIG. 2 is a side view of the embodiment;

FIG. 3 is another side view of the embodiment;

FIG. 4 is a perspective view of the embodiment;

FIG. 5 is another perspective view of the embodiment; and

FIG. 6 is a fragmentary schematic view of the embodiment showing a light-emitting element connected to a secondary circuit.

### DETAILED DESCRIPTION OF THE PREFERRED EMBODIMENTS

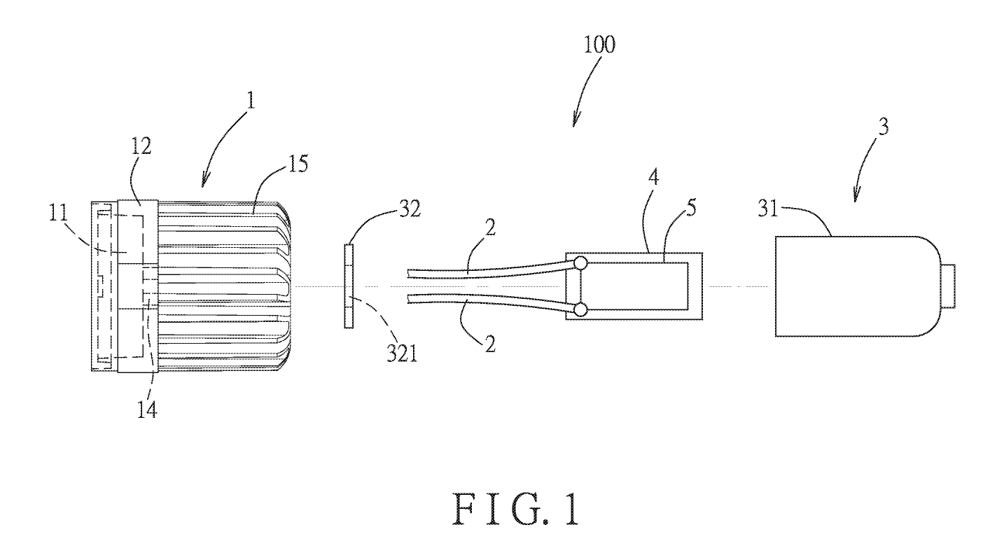

Referring to FIGS. 1 to 3, an embodiment of an illumination device 100 includes a lamp seat 1, two conductive wires 2, an insulating case 3, a circuit board 4, a primary circuit 5, a secondary circuit 6 and three light-emitting elements 7.

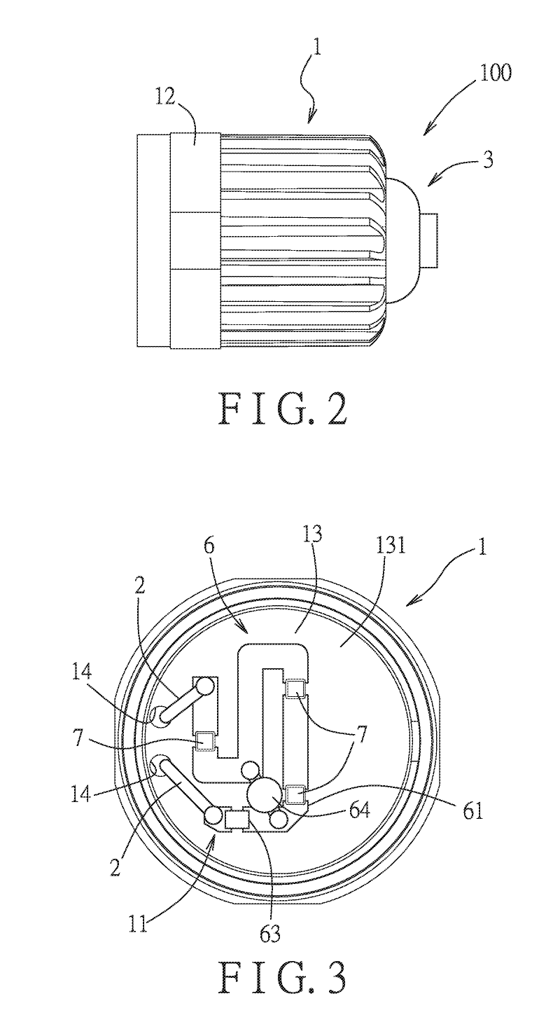

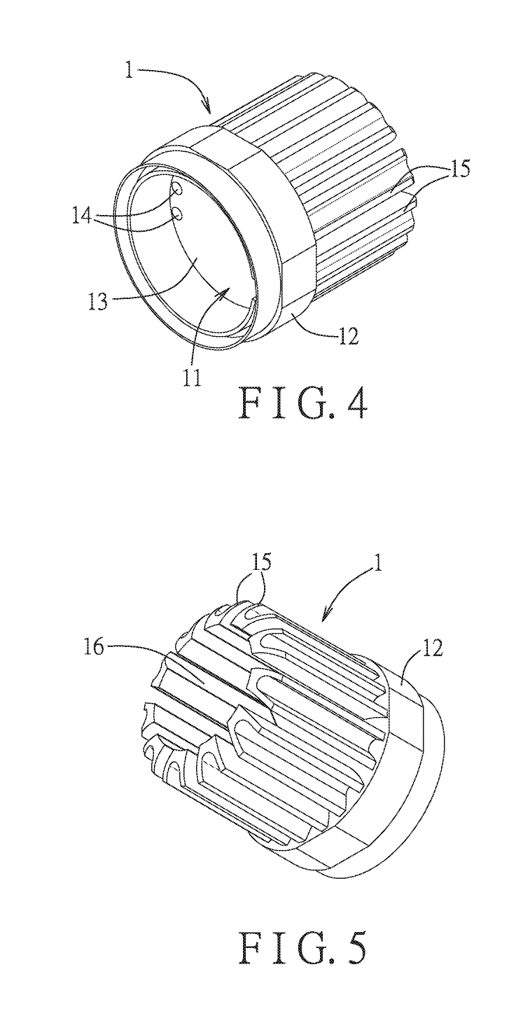

Referring to FIGS. 4 and 5, the lamp seat 1 includes a light exiting mount region 11, a metallic heat dissipating member 12, an insulating layer 13 formed on the metallic heat dissipating member 12, two through holes 14 and a plurality of heat dissipating fins 15 connected to and extending away from the metallic heat dissipating member 12. The lamp seat 1 further includes a space 16 surrounded by the heat dissipating fins 15 and bounded by the metallic heat dissipating member 12. In other words, the space 16 is defined cooperatively by the heat dissipating fins 15 and the metallic heat dissipating member 12. The insulating case 3 is received in the space 16 (see FIGS. 1 and 2). In certain embodiments, the metallic heat dissipating member 12 defines the light exiting mount region 11. The lamp seat 1 has an insulating surface 131 at the light exiting mount region 11. The insulating layer 13 defines the insulating surface 131, and is exemplified to be made of an electrically insulating and heat conductive material, such as aluminum oxide, boron nitride, aluminum nitride, etc. for facilitating heat dissipation. In certain embodiments, the through holes penetrate the metallic heat dissipating member 12 to intercommunicate the space 16 and the light exiting mount region 11.

Referring back to FIGS. 1 and 2, the primary circuit 5 is disposed on the circuit board 4. The primary circuit 5 and the circuit board 4 are received in the insulating case 3 to be prevented from being electrically connected to the lamp seat 1. In certain embodiments, the insulating case 3 includes a main body 31 and a cover 32. The main body 31 receives the circuit board 4 and the primary circuit 5. The cover 32 is disposed at an opening of the main body 31, and has a penetrating hole 321 for passage of the conductive wires 2. The insulating case 3 is connected to the lamp seat 1 distally of the light exiting mount region 11. Specifically, the insulating case 3 is connected to the lamp seat 1 distally of the light exiting mount region 11.

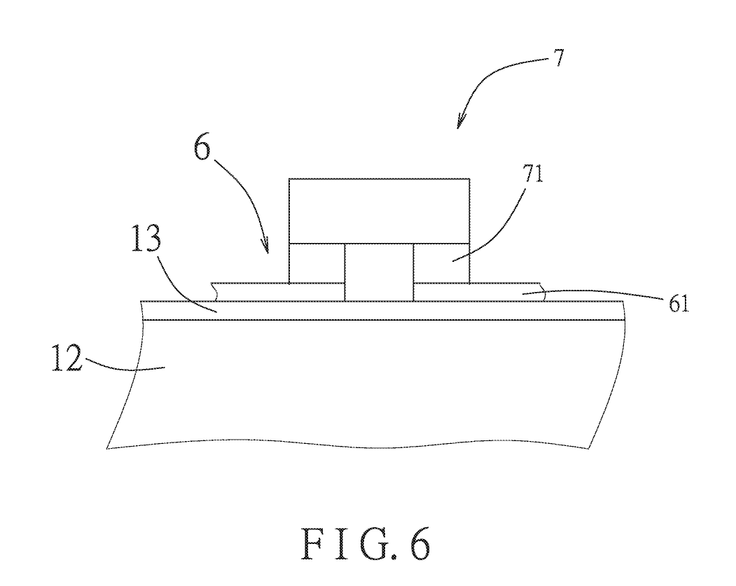

Referring to FIGS. 3 and 6, in certain embodiments, the secondary circuit 6 is disposed at the light exiting mount region 11, and includes a metal layer that forms a circuit wiring 61 on the insulating surface 131 and a plurality of electronic components, such as a diode 63 and a capacitor 64, that are electrically connected to the circuit wiring 61. By directly mounting the secondary circuit 6 to the insulating surface 131, an extra circuit board (not shown) is not required for mounting the secondary circuit 6, thereby saving manufacturing costs. In addition, omission of the extra circuit board is beneficial for heat dissipation. However, in case of need, the extra circuit board can be provided at the light exiting mount region 11, and the secondary circuit 6 can be mounted to the extra circuit board. In certain embodiments, the circuit wiring 61 can be created by forming an active metal layer (i.e., catalyst layer) on the insulating surface 131, followed by forming a chemically plated metal layer on the active metal layer.

The light-emitting elements 7 are disposed at the light exiting mount region 11 and are electrically connected to the secondary circuit 6. In certain embodiments, each of the light-emitting elements 7 is exemplified to be an LED, and includes a pair of metal leads 71 that are electrically connected to the circuit wiring 61. The number of the light-emitting elements 7 may be changed according to practical requirements. In certain embodiments, the illumination device 100 can include only one light-emitting element 7. Since the light-emitting elements 7 and the secondary circuit 6 are disposed at the light exiting mount region 11 with only the insulating layer 13 disposed therebetween, the heat generated by the secondary circuit 6 and the light-emitting elements 7 may be effectively transferred to the metallic heat dissipating member 12 and the heat dissipating fins 15, thereby achieving superior heat dissipation.

Referring to FIGS. 1 to 3, the conductive wires 2 respectively extend through the through holes 14 and electrically connect the primary circuit 5 and the secondary circuit 6. In certain embodiments, each of the conductive wires 2 is a triply insulated wire that has an electrically insulated outer sheath to thereby be electrically insulated from the metallic heat dissipating member 12. In certain embodiments, the lamp seat 1 may includes only one through hole 14 and the conductive wires 2 pass through the through hole 14 together.

In certain embodiments, the primary circuit 5 and the circuit board 4 are received in the space 16 and the insulating case 3, and are located opposite to the secondary circuit 6 relative to the metallic heat dissipating member 12, thereby allowing the primary circuit 5 and the secondary circuit 6 to be separated from each other for satisfying safety concerns. Moreover, the secondary circuit 6 is disposed at the light exiting mount region 11 instead of on the circuit board 4, such that the circuit board 4 can be minimized for accommodating only the primary circuit 5, and the overall size of the illumination device 100 can therefore be reduced. The space 16 surrounded by the heat dissipating fins 15 accommodates the insulating case 3, and the primary circuit 5 and the circuit board 4 received in the insulating case 3. However, based on actual requirements, the primary circuit 5 and the circuit board 4 may not be received in the space 16, and may be disposed at other locations away from the light exiting mount region 11 as long as the primary circuit 5 and the secondary circuit 6 are kept away from each other.

In summary, the secondary circuit 6 is disposed at the light exiting mount region 11 instead of on the circuit board 4, such that the circuit board 4 can be minimized for accommodating only the primary circuit 5 and the overall size of the illumination device 100 can therefore be reduced, and the primary circuit 5 and the secondary circuit 6 are separated from each other to satisfy safety concerns. Moreover, since the light-emitting elements 7 and the secondary circuit 6 are disposed at the light exiting mount region 11 with only the insulating layer 13 disposed therebetween, the heat generated by the secondary circuit 6 and the light-emitting elements 7 may be effectively transferred to the metallic heat dissipating member 12 and the heat dissipating fins 15, thereby achieving superior heat dissipation.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. An illumination device comprising:
a circuit board;
a lamp seat including a light exiting mount region;
a primary circuit disposed on said circuit board;
a secondary circuit disposed at said light exiting mount region;
a plurality of conductive wires electrically connecting said primary circuit and said secondary circuit; and
at least one light-emitting element disposed at said light exiting mount region and electrically connected to said secondary circuit.

2. The illumination device as claimed in claim 1, wherein said lamp seat has an insulating surface at said light exiting mount region, said secondary circuit including a metal layer forming a circuit wiring on said insulating surface.

3. The illumination device as claimed in claim 2, wherein said lamp seat further includes a metallic heat dissipating member that defines said light exiting mount region, and an insulating layer formed on said metallic heat dissipating member to define said insulating surface.

4. The illumination device as claimed in claim 1, wherein said lamp seat further includes at least one through hole for passage of said conductive wires.

5. The illumination device as claimed in claim 1, further comprising an insulating case that receives said circuit board.

6. The illumination device as claimed in claim 5, wherein said insulating case is connected to said lamp seat distally of said light exiting mount region.

7. The illumination device as claimed in claim 6, wherein said insulating case and said light exiting mount region are disposed at two opposite sides of said lamp seat.

8. The illumination device as claimed in claim 3, wherein:
said lamp seat further includes
a plurality of heat dissipating fins that are connected to and extend away from said metallic heat dissipating member, and
a space that is surrounded by said heat dissipating fins and that is bounded by said metallic heat dissipating member; and
said illumination device further comprises an insulating case that receives said circuit board and said primary circuit and that is received in said space.

9. The illumination device as claimed in claim 8, wherein:
said lamp seat further includes at least one through hole that penetrates said metallic heat dissipating member for intercommunication of said space with said light exiting mount region and passage of said conductive wires.

10. An illumination device comprising:
a circuit board;
a lamp seat formed with an insulating surface;
a primary circuit disposed on said circuit board;
a secondary circuit including a circuit wiring that is disposed on said insulating surface and that includes at least one electronic component connected to said circuit wiring;
a plurality of conductive wires electrically connected between said primary circuit and said secondary circuit; and
at least one light-emitting element connected to said circuit wiring of said secondary circuit.

11. The illumination device as claimed in claim 10, wherein said lamp seat further includes at least one through hole for passage of said conductive wires.

12. The illumination device as claimed in claim 10, further comprising an insulating case that receives said circuit board.

13. The illumination device as claimed in claim 12, wherein said insulating case is connected to said lamp seat distally of said insulating surface.

14. The illumination device as claimed in claim 13, wherein said insulating case and said insulating surface are disposed at two opposite sides of said lamp seat.

15. An illumination device comprising:
a lamp seat including a light exiting mount region and defining a space;
a circuit board received in said space;
a primary circuit disposed on said circuit board;
a secondary circuit disposed at said light exiting mount region;
a plurality of conductive wires electrically connecting said primary circuit and said secondary circuit; and
at least one light-emitting element electrically connected to said secondary circuit.

16. The illumination device as claimed in claim 15, wherein said lamp seat further includes a metallic heat dissipating member that defines said light exiting mount region, and a plurality of heat dissipating fins that are connected to and extend away from said metallic heat dissipating member to surround said space.

17. The illumination device as claimed in claim 16, wherein:
said lamp seat further includes at least one through hole that penetrates said metallic heat dissipating member to intercommunicate said space and said light exiting mount region; and
said conductive wires extend through said at least one through holes.

18. The illumination device as claimed in claim 15, wherein said illumination device further comprises an insulating case that receives said circuit board and said primary circuit and that is received in said space.

19. The illumination device as claimed in claim 18, wherein said insulating case is connected to said lamp seat distally of said light exiting mount region.

20. The illumination device as claimed in claim 18, wherein said insulating case and said light exiting mount region are disposed at two opposite sides of said lamp seat.
